(19) United States
(12) Patent Application Publication
(10) Pub. No.: US 2018/0334009 A1
(43) Pub. Date: Nov. 22, 2018

(54) EXTENDABLE RETRACTABLE PIVOTING SHACKLE ASSEMBLY

(71) Applicant: Dallas Smith Corp., Greencastle, IN (US)

(72) Inventors: Judson Smith, Greencastle, IN (US); Virgil R. Dutton, Ft. McDowell, AZ (US)

(73) Assignee: Dallas Smith Corp., Greencastle, IN (US)

(21) Appl. No.: 15/979,665

(22) Filed: May 15, 2018

Related U.S. Application Data
(60) Provisional application No. 62/506,769, filed on May 16, 2017.

(51) Int. Cl. B60G 17/02; B60G 11/04; B60G 11/10; B60G 11/12

(52) U.S. Cl. CPC B60G 17/023; B60G 11/04; B60G 11/10; B60G 11/12; B62D 65/12; B60G 2204/121; B60G 2204/61; B60G 2300/02; B60G 2202/112

(57) ABSTRACT

Disclosed is a variable length shackle assembly that includes a first frame member that includes a vehicle frame mount and a rail support and a second frame member that includes a leaf spring mount and a guide rail that cooperates with the rail support to permit the first frame member to move linearly relative to the second frame member while resisting non-linear movement and a biasing member such as a spring that connects that first frame member to the second frame member.

### CROSS-REFERENCE TO RELATED APPLICATIONS

This application claims the benefit of U.S. Provisional Application No. 62/506,769, filed May 16, 2017, which is hereby incorporated by reference.

### BACKGROUND

This disclosure is in the field of variable length pivoting shackles for coupling leaf springs to a vehicle frame.

Ever since vehicle leaf springs and shackles were first invented in London during the 18th century there have been numerous products invented, developed and sold to help soften, and to adjust for a level ride height of a leaf spring suspended vehicle.

Today, nearly three centuries later, certain vehicles have shackle-supported leaf spring suspensions for the front and rear wheels that could benefit from some type of softening and/or means for adjustment. Whether a vehicle is laded or unladed, leaf spring suspensions can produce harsh vehicle jounces and rebounds as the vehicle encounters chuckholes, bridge joints, railroad tracks, etc. Additionally, at normal driving speeds ribbon type roads can produce high frequency low amplitude vehicle vibrations that are transmitted through the leaf spring suspensions. Leaf spring suspensions may work best when they operate at the maximum allowable gross vehicle weight rating (GVWR) of the vehicle. However, some commercial vehicles operate significantly below their GVWR, and therefore their leaf spring suspensions can produce harsh snap-action bumps and recoils. A transit shuttle bus is an example of this type of vehicle. A single transit shuttle bus that is designed for transporting twenty-five (25) passengers is sometimes used for two separate and contrasting operating services.

One type of service might be its use for door-to-door single customer pick up and drop off—wherein the vehicle is laded hardly at all. In such cases the leaf springs can be extremely stiff and harsh-acting which can result in an uncomfortable ride for the single passenger, particularly for a passenger that may have a disability. The same transit shuttle bus may then be removed from that service category and placed into a totally different service category such as dedicated routes, wherein pick up and drop off of twenty five (25) passengers occurs. In such applications the leaf springs are laded to closer to, or at, the GVWR wherein the leaf springs are less stiff, but the harsh jounces and rebounds, along with high frequency low amplitude vibrations, can still exist. Additionally, the same transit shuttle bus may also have a very heavy wheelchair lift mounted on the passenger rear side of the vehicle, which can cause a side-to-side irregular suspension spring rate, which can produce uneven, non-level, and in some cases unsafe vehicle operating conditions.

A vehicle that carries a load that is greater than what the leaf spring is designed for will typically produce a suspension that is too soft and spongy which can result in bouncing harmonic type vibrations, that can also lead to having an unstable vehicle.

There are many suspension products that can soften, bolster, and adjust for leaf springs that are either too hard, too soft, and/or have uneven suspension spring rates from side-to-side, etc. These products include in part: air spring assist devices; hydraulic actuators; hydraulic shock absorbers; elastomeric bushings; elastomeric shear plates; adjustable elastomeric rebound jounce/rebound pads; torsion arms; coil springs; etc. These types of devices can be quite expensive, complex, and unable to be operated in a simple manner. Furthermore, many of these same devices can require costly modifications to the original vehicle chassis.

The prior art is quite extensive and widely known to those familiar to the field of vehicle suspensions, and the many devices and methods for dampening a vehicle leaf spring suspension. The prior art specific to vehicle leaf spring shackle devices used for the purposes of improving ride quality of leaf spring suspensions is much less extensive and is the field of art that this invention directly relates to.

Some patents which directly relate to leaf spring shackle devices for dampening leaf spring suspensions are represented, in part, by U.S. Pat. No. 1,412,349 issued to Joel; U.S. Pat. No. 2,323,065 issued to Martins; U.S. Pat. No. 1,379,321 issued to Thompson; U.S. Pat. No. 1,179,182 issued to Hofmann; U.S. Pat. No. 4,099,741 issued to Sweet, et al; U.S. Pat. No. 1,356,533 issued to Leager; U.S. Pat. No. 1,181,546 issued to Rosenthal; U.S. Pat. No. 2,006,439 issued to Chamberlain; U.S. Pat. No. 1,425,839 issued to Curtis; U.S. Pat. No. 3,083,034 issued to Hollowell; and, U.S. Pat. No. 3,294,390 issued to Warmkessel.

As can be seen, a significant number of the patented inventions listed are nearly 100 years old and were developed during the first part of the twentieth century when vehicle suspensions (typically operating with only leaf springs) were at the forefront of overall vehicle designs with an effort to provide better vehicle ride quality.

Martin's U.S. Pat. No. 2,323,065 is an example of a self-contained coil spring shackle device that accomplishes the objective of controlling the jounce (with a first coil compression spring) and rebound (with a second coil compression spring) effects of a leaf spring suspension. Multiple movements by the shackle engage the device's coil springs by means of a series of three (3) levers utilizing five (5) individual pivots ending in a final connection to the leaf spring. As the shackle moves with the leaf spring's fore, aft, and up and down movements, the centerline axis through the coil spring also pivots in different angular relationships to the travel arc of the related levers.

### SUMMARY

The disclosed embodiment of the variable length shackle provides an adjustable spring rate leaf spring shackle that can cushion the jounce and rebound events experienced by a vehicle under its various load conditions.

One object of the disclosed variable length shackle is to provide an adjustable spring rate shackle that can be installed at low cost and in a relatively simple manner on the vehicle's existing original shackle bracket—without requiring extensive disassembly of the leaf spring from the vehicle, or the removal and replacement of the vehicle's original shackle bracket, which as previously noted can be costly and time consuming.

A further object of the disclosed variable length shackle is to provide a leaf spring shackle that can essentially produce a lower, or higher, spring rate, and/or adjust the spring rate of one vehicle side to a different spring rate from its opposing side.

Another object of the disclosed variable length shackle is to provide a low cost solution that improves vehicle ride quality by uniform dampening of the hard jolt jounces and snap-action rebound forces, as well as to smooth out high frequency low amplitude vibrations that are inherent in most vehicles having leaf spring suspensions.

Additionally, an object of the disclosed variable length shackle is to provide a device that can replace the vehicle's original shackle and can be installed on the vehicle's original existing shackle support bracket.

Additionally, the disclosed variable length shackle provides the advantage of being installed on a vehicle's existing shackle bracket, which greatly reduces the cost of parts and installation. Furthermore, the disclosed variable length shackle incorporates an adjustment mechanism that permits increasing or decreasing the vehicle's effective suspension spring rate withough changing springs.

Further novel features and objects of the disclosed variable length shackle will become apparent to those of ordinary skill in the art from the following detailed description, drawings and claims.

### BRIEF DESCRIPTION OF THE DRAWINGS

FIG. 1 is a front view drawing of the variable length shackle assembly shown installed on a vehicle represented at ride height position.

FIG. 2 is an isometric exploded view of the FIG. 1 shackle.

FIG. 3 is an isometric view of the FIG. 1 shackle shown on a vehicle.

FIG. 4 is a front view drawing of the FIG. 1 shackle shown on a vehicle represented at a “jounce” position.

FIG. 5 is a front view drawing of the FIG. 1 shackle shown on a vehicle represented at a “rebound” position.

FIG. 6 is a cross-sectional front view drawing of the FIG. 1 shackle.

### DESCRIPTION OF THE ILLUSTRATED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein, are contemplated as would normally occur to one skilled in the art to which the invention relates.

With respect to the specification and claims, it should be noted that the singular forms “a”, “an”, “the”, and the like include plural referents unless expressly discussed otherwise. As an illustration, references to “a device” or “the device” include one or more of such devices and equivalents thereof. It also should be noted that directional terms, such as “up”, “down”, “top”, “bottom”, and the like, are used herein solely for the convenience of the reader in order to aid in the reader's understanding of the illustrated embodiments, and it is not the intent that the use of these directional terms in any manner limits the described, illustrated, and/or claimed features to a specific direction and/or orientation.

The disclosed variable length shackle operates more simply, accurately, and with less cost compared to other shackles by having just two (2) pivots and one (1) lever arm. It also maintains a direct centerline compression axis of its jounce and rebound compression springs, regardless of the movement of the shackle, and the leaf spring it is connected to. This provides a consistent straight line non-angular compression of the spring throughout its travel path.

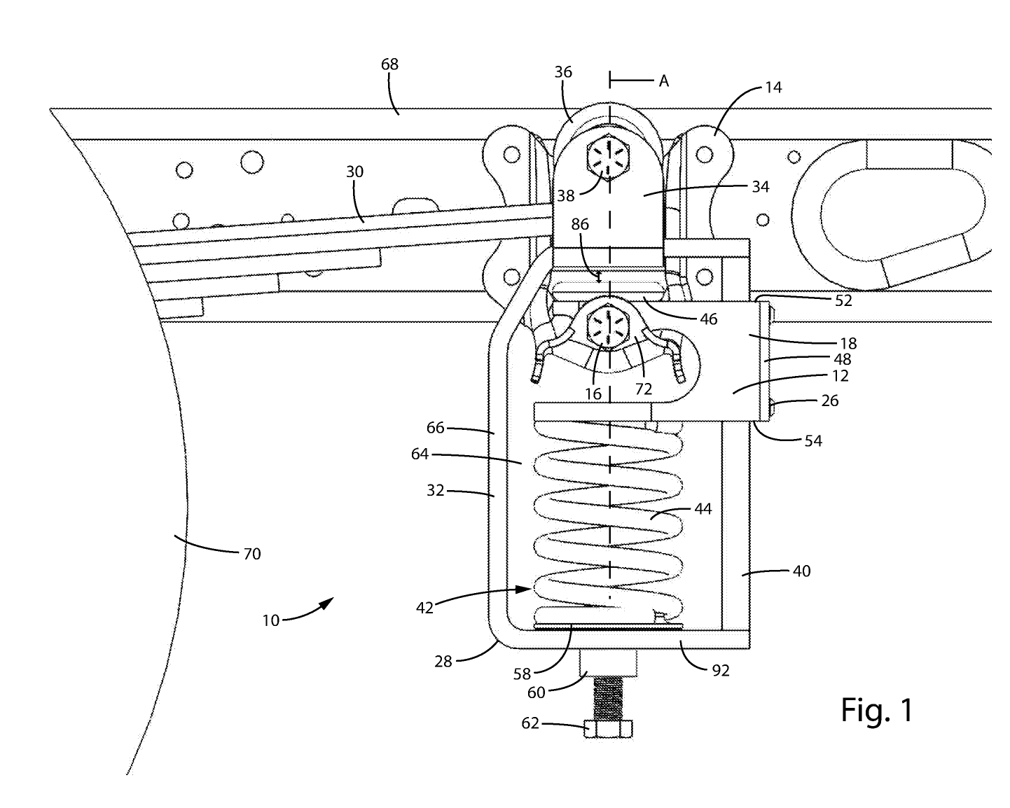

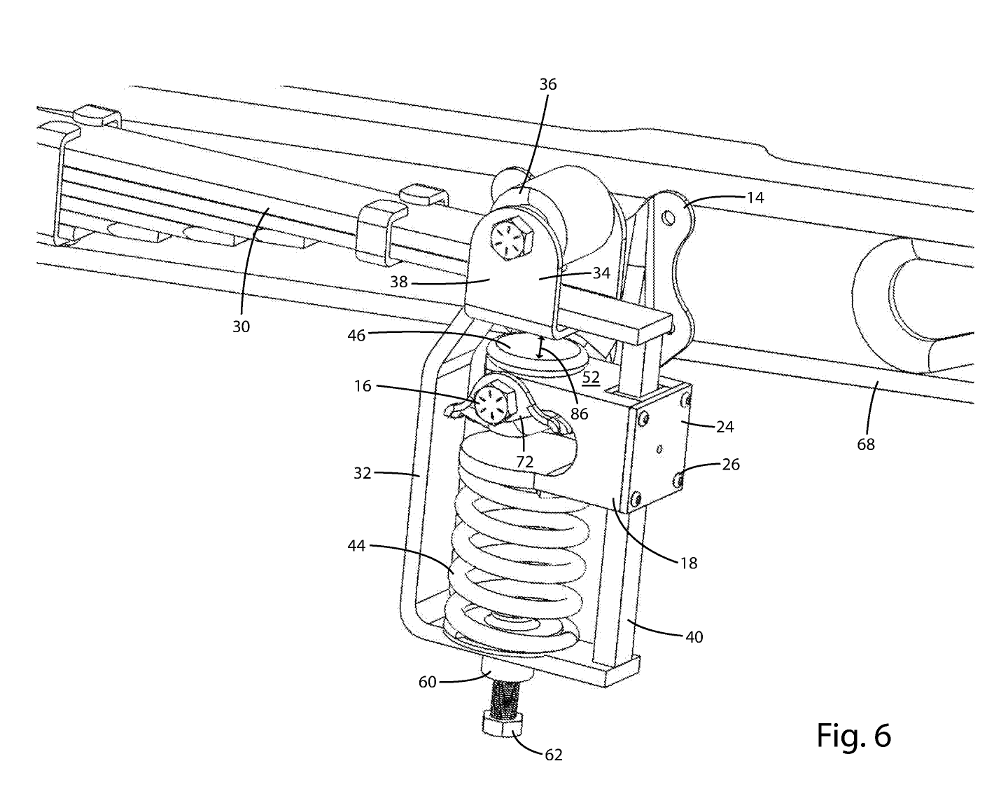

Disclosed is a variable length shackle 8 for mounting one end of a leaf spring to a vehicle's frame. Variable length shackle 8 is shown in FIGS. 1-6 as described below.

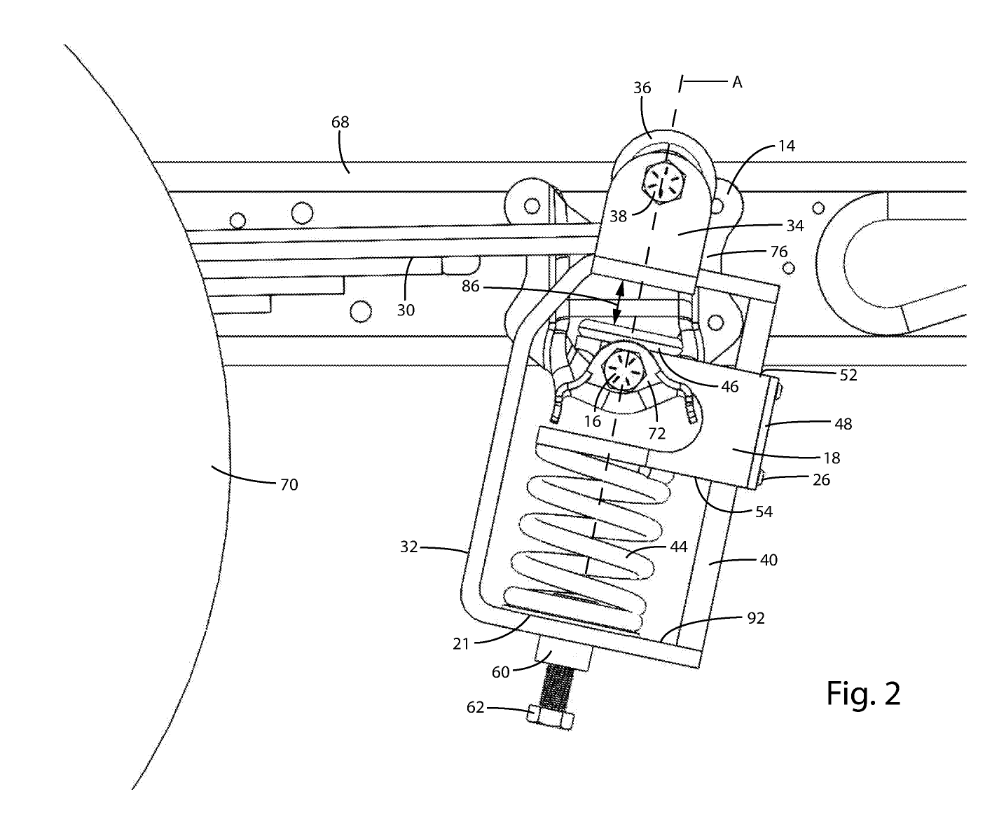

Variable length shackle 10 comprises a pivot assembly 12 secured to a frame-mounted spring bracket 14 by way of fastener 16. Pivot assembly 12 includes a pivot arm defining a recess 20 (FIG. 2) receiving a pair of guide bar slides 22 held in place by assembly plate 24 secured to pivot arm 18 by fasteners 26. See FIG. 2. Pivot assembly 12 is thereby configured to pivot relative to spring bracket 14 about the axis of fastener 16.

Variable length shackle 10 further comprises a leaf spring slide bracket assembly 28 for attachment of leaf spring 30. Slide assembly 28 includes a C-shaped slide frame 32, and a leaf spring clevis 34 secured thereto. Eye pivot mount 36 of leaf spring 30 is secured to leaf spring clevis 34 by fastener 38.

Guide bar 40 extends between and is secured to the ends of slide frame 32. Slide assembly 28 is coupled to pivot assembly 12 by the capturing of guide bar 40 between slide plates 22 during assembly of pivot assembly 12. Slide assembly 28 is thereby configured to slide relative to pivot assembly 12 along a lengthwise axis A parallel to guide bar 40. Slide assembly 28 is also thereby configured to pivot with pivot assembly 12 relative to spring bracket 14 about the fastener 16 axis.

Variable length shackle 10 further includes a biasing assembly 42 acting on the position of slide assembly 28 relative to pivot assembly 12. Biasing assembly 42 is shown in FIG. 1 in one embodiment as comprising a coil spring 44. Spring 44 urges slide assembly 28 to a neutral position in response to either jounce or rebound.

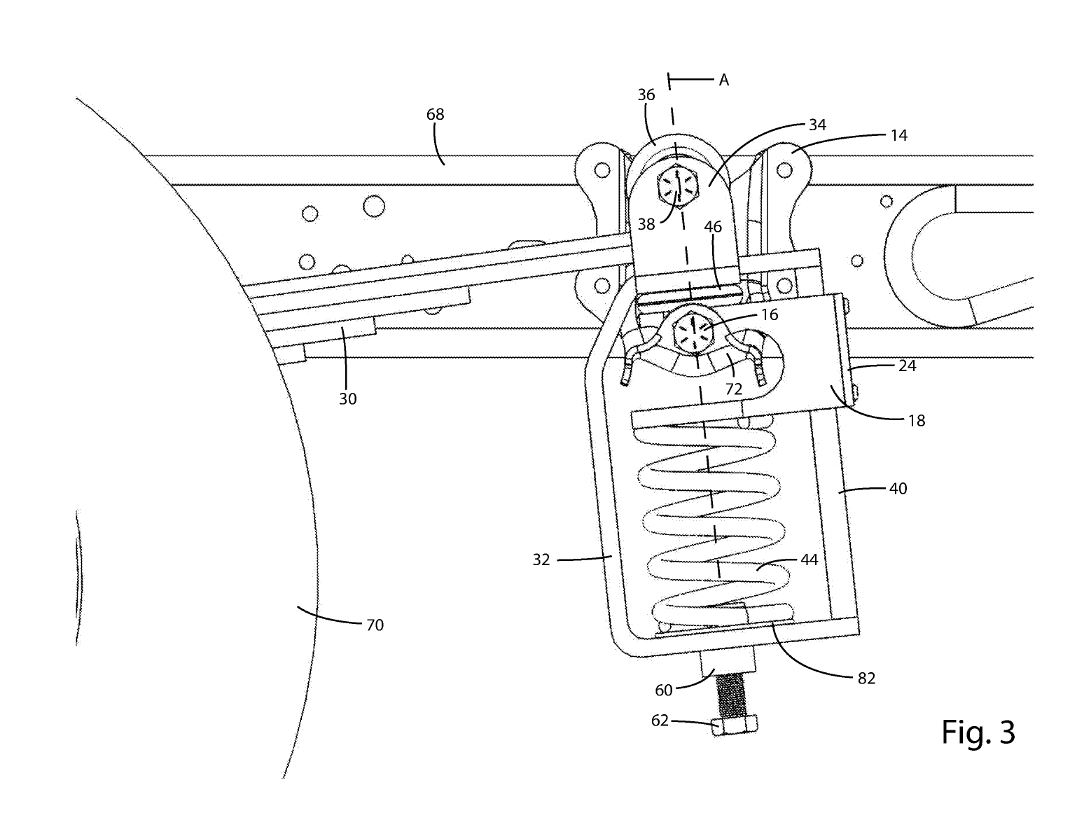

Variable length shackle 10 is shown in FIG. 1 in a neutral position. With jounce, as shown in FIG. 2, eye pivot mount 36 of leaf spring 30 moves up and extends to the right, resulting in compression of spring 44 and clockwise pivoting of pivot assembly 12. With rebound, eye pivot mount 36 of leaf spring 30 moves down and to the left, as shown in FIG. 3, resulting in extension of spring 44 and counterclockwise pivoting of pivot assembly 12.

Pivot assembly 12 includes pivot arm 18, cushion 46, plate 48, slides 22 and pivot aperture 50. Pivot arm 18 defines top surface 52 and bottom surface 54. Pivot assembly 12 also defines opening 56 and recess 20. Opening 56 is located between bottom surface 54 and pivot aperture 50, with opening 56 spacing bottom surface 54 apart from pivot aperture 50. Opening 56 is specifically configured to receive an unmodified OEM (Original Equipment Manufacture) frame mounted leaf spring shackle bracket for a particular vehicle. Recess 20 is positioned on a side of pivot arm 18 opposite opening 56, with recess 20 extending through pivot arm 18 from top surface 52 to bottom surface 54. In the illustrated embodiment, spring 44 abuts bottom surface 54.

Biasing assembly 42 generally includes spring 44 and landing plate 58, with spring 44 defining a biasing member.

Slide assembly 28 generally includes frame 32, clevis 34, guide bar 40, receiving nut 60 and adjustment bolt 62. Frame 32 of slide assembly 28 generally approximates a C-shape that defines hollow 64 between clevis 34 and receiving nut 60. Guide bar 40 is rigidly fixed to frame 32 opposite middle portion 66. In the illustrated embodiment, at least a portion of middle portion 66 is parallel to guide bar 40.

Pivot assembly 12 is coupled to guide bar 40 by positioning guide bar 40 and slides 22 within recess 20 with plate 24 coupled to pivot arm 18 with fasteners 26. Guide bar 40 and slides 22 are substantially entrapped within recess 20 by assembly plate 24. Slides 22 permit linear movement of guide bar 40 relative to pivot arm 18. However, the non-circular shape of guide bar 40 and the complementary shape of slides 22 and recess 20 cooperate to substantially prevent relative rotation between guide bar 40 and pivot arm 18. In addition, the complementary shape of slides 22 and recess 20 substantially prevent motion of pivot arm 18 relative to guide bar 40 except for along the length of guide bar 40.

Adjustment bolt 62 is coupled to frame 32 and to landing plate 58 which is coupled to spring 44 which is coupled to pivot arm 18. When variable length shackle 10 is installed as shown in FIG. 1, the weight of the vehicle compresses spring 44 between pivot arm 18 and frame 32. Pivot arm 18 is fixed in position relative to frame 68 (although pivot arm 18 can rotate relative to vehicle frame 68) while clevis 34 and frame 32 move relative to pivot arm 18.

As can be seen in FIGS. 2 and 3, as clevis 34 and frame 32 move relative to pivot arm 18 due to forces exerted by leaf spring 30 through mount 36, pivot arm 18 and frame 32 rotate relative to pivot aperture 50 (which rotates about fastener 16 that is affixed to vehicle frame 68 through the frame mounted leaf spring bracket).

Fasteners 38 and 16 define the points where variable length shackle 10 is coupled between vehicle frame 68 and leaf spring 30. Axis A extends through the center of fasteners 38 and 16. Variable length shackle 10 is configured such that axis A also extends roughly through a centerline of spring 44 throughout a range of rotational motion of pivot arm 18 relative to frame 68, which is also shown in FIGS. 2 and 3.

FIG. 1 shows a vehicle wheel 70 that is attached to a vehicle's axle (not shown) which is further attached to leaf spring 30. Both ends of leaf spring 30 are attached to vehicle frame 68. The end that is not illustrated may be coupled to vehicle frame 68 using the OEM attachment mounts, while the illustrated end is mounted to the frame with variable length shackle 10.

Specifically, eye pivot mount 38 of leaf spring 30 is coupled to clevis 34 by fastener 38. Clevis 34 is fixedly attached to frame 32 that includes the fixedly attached guide bar 40 and a fixedly attached receiving nut 60. Pivot arm 18 defines shackle pivot aperture 50 that receives fastener 16 extending from the shackle bracket's outboard end 72 through bushings 74 to the shackle bracket's inboard end 76.

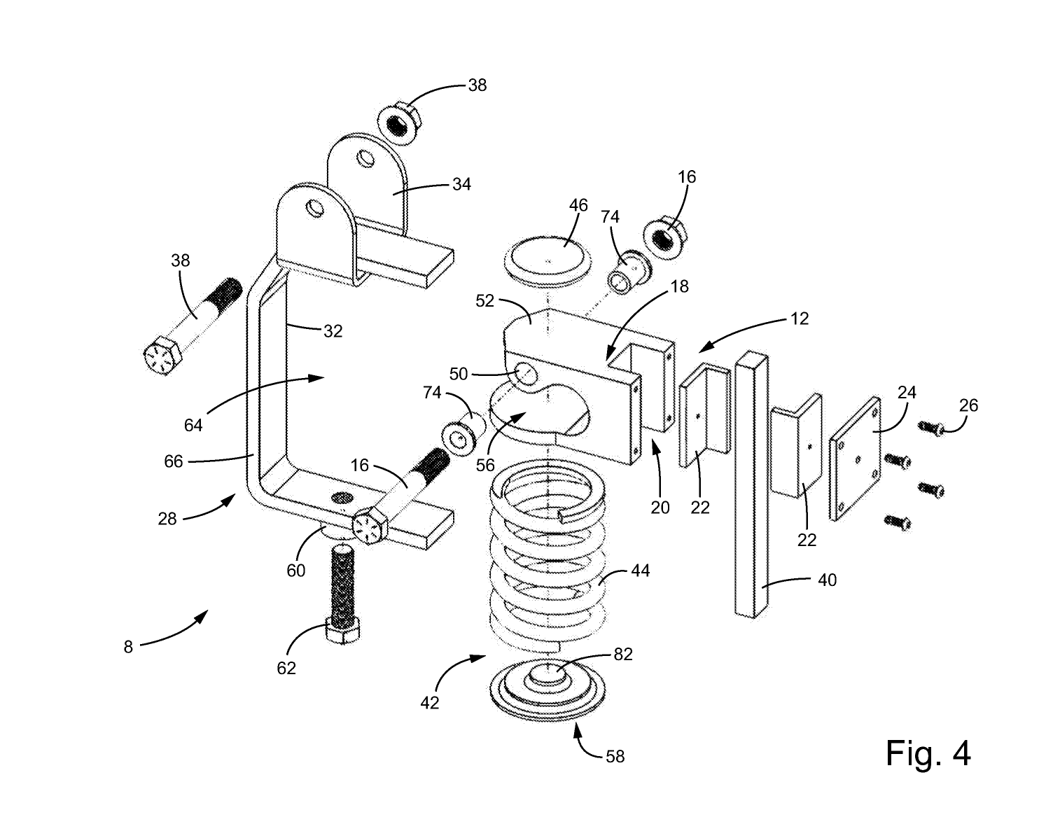

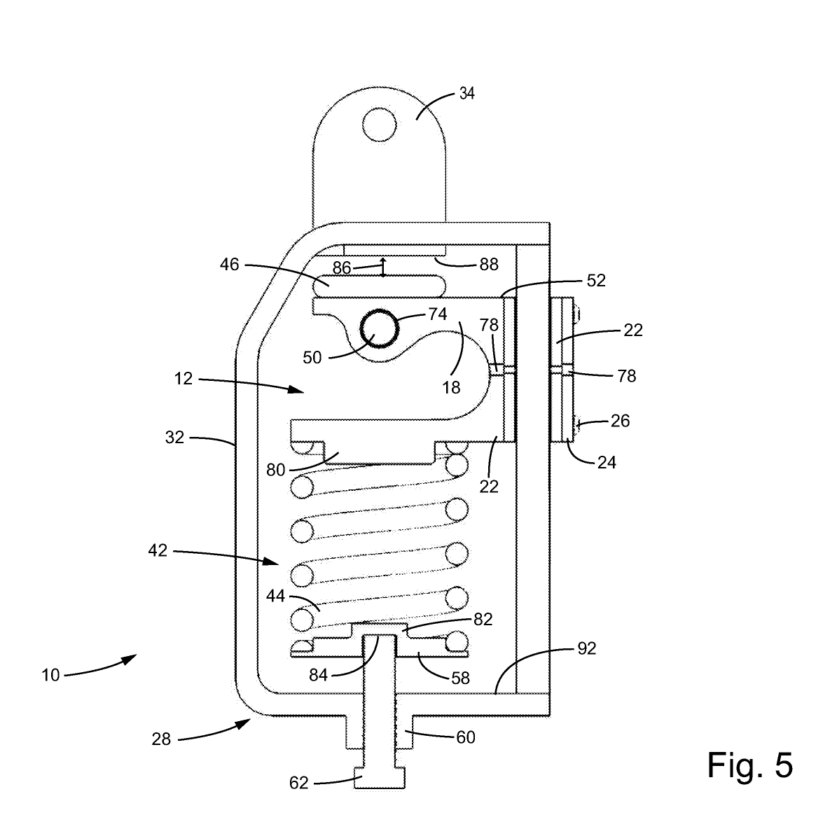

Now referring more particularly to FIG. 4 and FIG. 5, pivot arm 18 includes slides 22, associated retaining pins (see FIG. 5), and assembly plate 24 and related plate fasteners 26. Slides 22 permit relative movement of pivot arm 18 relative to guide bar 40 and frame 32.

FIGS. 1, 4, and 5 also show frame 32, as well as cushion 46 that is fixedly attached to top surface 52 of pivot arm 18. Cushion 46 is thereby positioned between clevis 34 and pivot arm 18. FIG. 5 shows the bottom horizontal surface face of pivot arm 18 including a shackle spring upper mount 80 providing a retaining location for spring 44. Also shown in FIG. 5, spring 44 is retained on lower mount 82 of landing plate 80, which further includes a recess 84 receiving adjustment bolt 62.

It should be noted that although spring 44 is shown as a conventional metal coil spring, other spring designs and material could be used as effectively. Examples of such alternate spring designs are elastomeric springs produced by SuperSprings International under the product name Sumo Springs®, and Timbren Industries, Inc. Aeon® Springs. Additionally, spring material such as that used as elastomeric pad 14 may be used, e.g. Atro Engineered Systems, Inc.'s 68-72 Shore A “Dead Soft™” polyurethane material. Also, a steel coil or a wave type of spring could be used as well. Spring 19 can be generally characterized as having a constant spring rate.

FIGS. 1, 2, and 3 will be fully described to provide a more complete explanation and understanding of the preferred embodiments of the invention.

To illustrate an example—when vehicle frame 68 is suspended by a leaf spring 30, it is at its ride height position as shown in FIG. 1. In this position, variable length shackle 10 is generally in a vertical perpendicular alignment to vehicle frame 68. FIGS. 1 and 5 show a distance 86 between cushion 46 and bottom surface 88 of top portion 90 of frame 32. Distance 86 between cushion 46 and bottom surface 88 is at its generally centered position as well. When a vehicle is moving in a linear direction and the wheel 70 encounters a bump in the road, an upward force (jounce) causes leaf spring 30 and mount 36 to move in an upward and rearward motion as shown in FIG. 2, which results in an increase in distance 86 between frame 32 and pivot arm 18. As the leaf spring 30 and mount 36 encounter a jounce event, the centerline axis of bottom portion 92 of frame 32, which supports spring 44 through a lower mount 82, receiving nut 60, adjustment bolt 62, and guide bar 40, also move upward an equidistance with frame 32, and with a direct centerline axial force, from the centerline axis of adjustment bolt 62 through the centerline axis of the shackle pivot aperture 50 and through the centerline axis of frame 32—a centerline axis of all components throughout the shackle's movement—upward and rearward.

Conversely, as the leaf spring 30 and mount 36 encounter a rebound event, as shown in FIG. 3, such as where wheel 70 encounters a chuck hole in the road surface, frame 32, which supports spring 44 through lower mount 82, receiving nut 60, adjustment bolt 62, and guide bar 40 also move downward an equidistance with frame 32, and with a direct centerline axial force from the centerline axis of the adjustment bolt 62 through the centerline axis of shackle pivot aperture 50 and through its centerline axis to mount 36—throughout the shackle's movement—downward and forward.

Guide bar 40 in conjunction with the pivot arm 18 also acts as a “yaw” control for the vehicle's suspension by not allowing variable length shackle 10 to drift. Variable length shackle 10 will remain stable and in direct parallel arrangement and operating alignment to the vehicle's chassis with the guide bar 40 enclosed within slides 22, even when the vehicle encounters a single wheel jounce or compression, as experienced by a vehicle on a sloped inclined road. Additionally, cushion 46 is a spring type material that acts to cushion the bottom surface 80 of frame 32 against top surface 52 of pivot arm 18 when distance 86 is zero as shown in FIG. 3.

As can be seen in FIG. 4 and FIG. 5, pivot arm 18 and guide bar 40 (shown in FIG. 4 as being detached for explanation purposes only) through their fixedly attached arrangements to frame 32 and mount 36, show that all said components will travel jointly in any direction moved. Guide bar 40 travels inside slides 22 in pivot arm 18. Plate 24 is secured to pivot arm 18 by fasteners 26 and secures guide bar 40 within slides 22. An example of preferred material for slides 22 is UHMW polyurethane, but any antifriction type material can be used including a liquid lubricant. If slides 22 are used, then retainer pins 78 (as shown in FIG. 5) can be utilized to hold slides 22 in position. If lubricant is used then the opening for retainer pins 78 could be used for grease injection, for example with a grease fitting installed in the opening (not illustrated).

The effective spring rate of spring 44 can optionally be adjusted. For example, if a vehicle has uneven side-to-side leaf spring rates. Moving adjustment bolt 62 relative to frame 32 also moves pivot assembly 12 and biasing assembly 42 relative to slide assembly 28. Turning adjustment bolt 62 clockwise extends adjustment bolt 62 and pushes lower mount 82 (and therefore biasing assembly 42 and pivot assembly 12) away from bottom portion 92 of frame 32. Adjustment bolt 62 can be extended to the point that distance 86 is zero and cushion 46 abuts bottom surface 88 of frame 32. At this point, continued clockwise turning of adjustment bolt 62 adds compression to spring 44 and cushion 46, which changes the effective spring rate of spring 44 and the overall performance of variable length shackle 10. Furthermore, extending adjustment bolt 62 less than what is required for cushion 46 to abut bottom surface 88 also changes the effective spring rate of spring 44 in some circumstances, as a smaller rebound is needed for cushion 46 to abut bottom surface 88. Rotating adjustment bolt 62 counterclockwise results in reversing the changes in the effective spring rate of spring 44 until adjustment bolt 62 is retracted to the position shown in FIG. 1.

FIG. 1 illustrates the configuration of variable length shackle 10 in a stationary or a ride height position where external influences such as bumps or dips do not influence the compression of biasing assembly 42. In this condition, slide assembly 28 is loaded with a tensile load between clevis 34 and adjustment bolt 62. Conversely, biasing assembly 42 is compressed between pivot assembly 12 and slide assembly 28.

The disclosed variable length shackle 10 can be used to retrofit an OEM vehicle by removing the OEM leaf spring shackle from the frame and the leaf spring then attaching variable length shackle 10 to the OEM frame mounted leaf spring bracket with fastener 16 passing through aperture 50 and then attaching variable length shackle 10 to the leaf spring with fastener 38 that passes through clevis 34. An effective spring rate of variable length shackle 10 can then optionally be adjusted by rotating adjustment bolt 62.

There thus has been described a variable length shackle assembly comprising a first frame member defining a first mount and a rail support, wherein the first mount is adapted to be coupled to a vehicle frame. The assembly further includes a second frame member defining a second mount, the second frame member comprising a guide rail. The rail support and the guide rail cooperate to permit the second frame member to move linearly relative to the first frame member along a first direction while resisting movement of the second frame member relative to the first frame member along other directions. The second mount is adapted to be coupled to a leaf spring eye. The assembly further comprises a biasing member connecting the first frame member to the second frame member.

In another aspect, the variable length shackle assembly further comprises an adjustment member movable relative to the second frame member, wherein the adjustment member is positioned between the second frame member and the biasing member. Movement of the adjustment member relative to the second frame member also moves the position of the biasing member and the first frame member relative to the second frame member. In a related aspect, the second frame member of the variable length shackle assembly further comprises a frame element that is spaced apart from the guide rail.

The variable length shackle assembly may include the first mount on the first frame member being positioned between the guide rail and the frame element. Further, the frame element and the guide rail may rigidly space the second mount and the adjustment member apart. In a further embodiment, the frame element and the guide rail are parallel.

In another embodiment, the second frame member defines an internally threaded nut and the adjustment member is a bolt that is threadingly engaged with the internally threaded nut. The biasing member may be a spring having a spring rate and wherein moving the adjustment member relative to the second frame member changes the effective spring rate of said spring.

In embodiments, the guide rail and the rail support cooperate to resist rotation of the second frame member relative to the first frame member. In other embodiments the first frame member comprises a biasing member abutment surface that is spaced apart from the first mount and wherein the first frame member defines an opening that extends between the biasing member abutment surface and the first mount. Further, the opening may be adapted to receive a frame mounted leaf spring shackle bracket. The first mount may be adapted to receive a first fastener to couple the first frame member to the frame mounted leaf spring shackle bracket. Moreover, the opening may be specifically adapted to receive a vehicle specific unmodified OEM leaf spring shackle bracket. Also, the variable length shackle assembly may further comprise a resilient cushion on the first frame member, wherein the resilient cushion is positioned between the first and second mounts.

The variable length shackle assembly may include the first frame member further comprising a biasing member abutment surface on a side of the first frame member that is opposite a position of the second mount. In a related aspect, the biasing member is positioned along an axis that extends between the first and second mounts. The first frame member further comprises a cover and wherein the first frame member defines a recess that contains the rail support in cooperation with said cover.

In some embodiments there is provided a vehicle comprising the variable length shackle assembly as herein described and a vehicle frame, wherein the second mount of the shackle assembly is coupled to the vehicle frame. The leaf spring is coupled to the vehicle frame on a first end and coupled to the first mount of the shackle assembly on a second end.

When the vehicle is not moving, a tensile load between the second mount and the biasing member may be applied to the second frame member. Further, when the vehicle is not moving, a load between the first and second frame members may compress the biasing member.

In yet another aspect there is provided a method of retrofitting a vehicle with the variable length shackle assembly described herein. The method comprises removing a shackle assembly from a first end of a leaf spring, and removing the shackle assembly from a frame mounted leaf spring bracket on the vehicle frame, wherein a second end of the leaf spring is coupled to the frame. The method further comprises attaching the first mount of the shackle assembly to the frame mounted leaf spring bracket, and attaching the second mount of the claim 1 variable length shackle assembly to the first end of the leaf spring. The method may further include adjusting the effective spring rate of the biasing member by moving an adjustment member relative to the second frame member, thereby moving the biasing member and the first frame member relative to the second frame member.

While the disclosure has been illustrated and described in detail in the drawings and foregoing description, the same is to be considered as illustrative and not restrictive in character, it being understood that only the preferred embodiments have been shown and described and that all changes and modifications that come within the spirit of the disclosure are desired to be protected.

### REFERENCE NUMBERS

A Axis of Variable Length Shackle
10 Variable Length Shackle—Complete Assembly
12 Pivot assembly
14 Frame Mounted Leaf Spring Shackle Bracket—Inboard End
16 Fastener
18 Pivot Arm
20 Recess in Pivot Arm 11
22 Guide Bar Slides
24 Access Assembly Plate
26 Access Assembly Plate Fasteners
28 Slide assembly
30 Leaf Spring
32 Frame
34 Leaf Spring Clevis
36 Leaf Spring—Eye Pivot Mount
38 Eye Pivot Mount Fastener
40 Guide Bar
42 Biasing assembly
44 Shackle Spring
46 Cushion
50 Shackle Pivot aperture
52 Top surface of Pivot arm 11
54 Bottom surface of Pivot arm 11
56 Opening in Pivot Arm 11
58 Landing Plate
60 Adjustment Bolt Receiving Nut
62 Adjustment Bolt
64 Hollow in Frame 9
66 Middle portion of Frame 9
68 Vehicle Frame
70 Vehicle Wheel
72 Frame Mounted Leaf Spring Shackle Bracket—Outboard End
74 Bushings
78 Guide Bar Slides' Retaining Pins
80 Upper Mount
82 Lower Mount
86 Distance between Cushion 14 and Bottom surface 9.1
88 Bottom surface of 90
90 Top portion of Frame 9
92 Bottom portion of Frame 9
A Axis of Variable Length Shackle

I claim:

1. A variable length shackle assembly comprising:
a first frame member defining a first mount and a rail support, wherein the first mount is adapted to be coupled to a vehicle frame;
a second frame member defining a second mount, wherein the second frame member comprises a guide rail, wherein the rail support and the guide rail cooperate to permit said second frame member to move linearly relative to the first frame member along a first direction while resisting movement of said second frame member relative to said first frame member along other directions, wherein the second mount is adapted to be coupled to a leaf spring eye; and
a biasing member connecting said first frame member to said second frame member.

2. The variable length shackle assembly of claim 1, further comprising an adjustment member movable relative to said second frame member, wherein said adjustment member is positioned between said second frame member and said biasing member and wherein movement of said adjustment member relative to said second frame member also moves a position of said biasing member and said first frame member relative to said second frame member.

3. The variable length shackle assembly of claim 2, wherein said second frame member further comprises a frame element that is spaced apart from said guide rail.

4. The variable length shackle assembly of claim 3, wherein the first mount on said first frame member is positioned between said guide rail and said frame element.

5. The variable length shackle assembly of claim 4, wherein said frame element and said guide rail rigidly space the second mount and said adjustment member apart.

6. The variable length shackle assembly of claim 5, wherein said frame element and said guide rail are parallel.

7. The variable length shackle assembly of claim 2, wherein said second frame member defines an internally threaded nut and wherein said adjustment member is a bolt that is threadingly engaged with the internally threaded nut.

8. The variable length shackle assembly of claim 2, wherein said biasing member is a spring having a spring rate and wherein moving said adjustment member relative to said second frame member changes an effective spring rate of said spring.

9. The variable length shackle assembly of claim 1, wherein said guide rail and said rail support cooperate to resist rotation of said second frame member relative to said first frame member.

10. The variable length shackle assembly of claim 1, wherein said first frame member further comprises a biasing member abutment surface that is spaced apart from the first mount and wherein said first frame member defines an opening that extends between said biasing member abutment surface and the first mount.

11. The variable length shackle assembly of claim 10, wherein the opening is adapted to receive a frame mounted leaf spring shackle bracket.

12. The variable length shackle assembly of claim 11, wherein the first mount is adapted to receive a first fastener to couple said first frame member to said frame mounted leaf spring shackle bracket.

13. The variable length shackle assembly of claim 12, wherein the opening is specifically adapted to receive a vehicle specific unmodified OEM leaf spring shackle bracket.

14. The variable length shackle assembly of claim 10, further comprising a resilient cushion on said first frame member, wherein said resilient cushion is positioned between the first and second mounts.

15. The variable length shackle assembly of claim 1, wherein said first frame member further comprises a biasing member abutment surface on a side of said first frame member that is opposite a position of the second mount.

16. The variable length shackle assembly of claim 15, wherein said biasing member is positioned along an axis that extends between the first and second mounts.

17. The variable length shackle assembly of claim 1, wherein said first frame member further comprises a cover and wherein said first frame member defines a recess that contains said rail support in cooperation with said cover.

18. A vehicle comprising:
the variable length shackle assembly of claim 1;
a vehicle frame, wherein the second mount of the claim 1 variable length shackle assembly is coupled to the vehicle frame; and
a leaf spring coupled to the vehicle frame on a first end and coupled to the first mount of the claim 1 variable length shackle assembly on a second end.

19. The vehicle of claim 18, wherein, when the vehicle is not moving, a tensile load between said second mount and said biasing member is applied to said second frame member.

20. The vehicle of claim 19, wherein, when the vehicle is not moving, a load between said first and second frame members compresses said biasing member.

21. A method of retrofitting a vehicle with the variable length shackle assembly of claim 1, the method comprising:
removing a shackle assembly from a first end of a leaf spring;
removing the shackle assembly from a frame mounted leaf spring bracket on a frame, wherein a second end of the leaf spring is coupled to the frame;
attaching the first mount of the claim 1 variable length shackle assembly to the frame mounted leaf spring bracket; and
attaching the second mount of the claim 1 variable length shackle assembly to the first end of the leaf spring.

22. The method of claim 21, further comprising:
adjusting an effective spring rate of the biasing member by moving an adjustment member relative to the second frame member thereby moving the biasing member and the first frame member relative to the second frame member.
